(19) United States
(12) Patent Application Publication
(10) Pub. No.: US 2009/0014076 A1
(43) Pub. Date: Jan. 15, 2009

(54) BLEED VALVE APPARATUS

(75) Inventor: Akinori Hirano, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/137,705

(22) Filed: Jun. 12, 2008

(30) Foreign Application Priority Data
Jul. 13, 2007 (JP) 2007-184424

(51) Int. Cl. F16K 31/06; F16K 3/00

(52) U.S. Cl. 137/625.6; 251/318

(57) ABSTRACT

A bleed valve apparatus includes a valve body having a sliding hole in which a spool is axially movable. A seat member and the spool define a bleed chamber. An open-close unit opens and doses a bleed port of the seat member to control exhaust of fluid from the bleed chamber through the bleed port. The spool has a spool end surface at the side of the seat member. The spool end surface and a seated surface of the seat member are inclined with respect to each other to therebetween define an inclination clearance, which communicates a supply port with the bleed chamber to supply fluid to the bleed chamber through the supply port when the spool is seated to the seated surface.

### CROSS REFERENCE TO RELATED APPLICATIONS

This application is based on and incorporates herein by reference Japanese Patent Application No. 2007-184424 filed on Jul. 13, 2007.

### FIELD OF THE INVENTION

The present invention relates to a bleed valve apparatus having a bleed chamber for hydraulically manipulating a spool.

### BACKGROUND OF THE INVENTION

For example, U.S. Pat. No. 6,615,869 B2 (JP-A-2002-357281) discloses a bleed valve apparatus as an example of a solenoid hydraulic pressure control valves which actuates a spool by applying hydraulic pressure in a bleed chamber. The solenoid hydraulic pressure control valve disclosed in U.S. Pat. No. 6,615,869 B2 is described with reference to FIGS. 5, 6A, 6B.

A solenoid hydraulic pressure control valve is configured to actuate a spool 4 by applying pressure axially from a bleed chamber 34 in a three-way spool valve 1. The solenoid hydraulic pressure control valve includes a spool-return spring 5 and a solenoid bleed valve 2. The spool-return spring 5 biases the spool 4 along a slidable direction to the right in FIG. 5. The solenoid bleed valve 2 controls pressure in the bleed chamber 34. The solenoid bleed valve 2 includes a seat member 31, a valve 32, and a solenoid actuator 33. The seat member 31 and the spool 4 therebetween define a bleed chamber 34, to which pressurized oil is supplied. The seat member 31 has a bleed port 35, which communicates the bleed chamber 34 with a low-pressure component. The valve 32 opens and closes the bleed port 35. The solenoid actuator 33 actuates the valve 32. When the spool 4 is seated to the seat member 31, the communication between a supply port 12 and the bleed chamber 34 is blockaded by the spool 4, whereby supply of oil through the supply port 12 is stopped. When the spool 4 is lifted from the seat member 31, the supply port 12 communicates with the bleed chamber 34. The seat member 31 is substantially in a cylindrical shape and has the bleed chamber 34 therein. The end surface of the seat member 31 defines an annular seat surface as a seat-side seated surface 62, which has the circumferential periphery configured to make contact entirely with the spool 4. The spool 4 has a spool end surface, which is seated to the seat member 31 of the spool 4. As described above, when the spool end surface is seated to the seat-side seated surface 62 of the seat member 31, the communication between the supply port 12 and the bleed chamber 34 is blockaded by the spool 4.

If the supply port 12 is completely blockaded from the bleed chamber 34 in a condition where the spool 4 is seated to the seat member 31, oil cannot be supplied to the bleed chamber 34. In this condition, even when the bleed port 35 is blockaded by the valve 32, hydraulic pressure does not occur in the bleed chamber 34.

Therefore, in the present structure, a small communication unit is provided to slightly lead oil from the supply port 12 to the bleed chamber 34 even when the spool 4 is seated to the seat-side seated surface 62. When the spool 4 is seated to the seat member 31, and in order to lift the seated spool 4, the opening of the bleed port 35 needs to be reduced by, for example, blockading the bleed port 35. Specifically, when the bleed port 35 is blockaded, the amount of oil flowing into the bleed chamber 34 through the small communication unit becomes larger than the amount of oil exhausted from the bleed port 35, whereby hydraulic pressure in the bleed chamber 34 is increased to lift the spool 4. Thus, hydraulic pressure as lift hydraulic pressure needs to be generated in the bleed chamber 34 in the bleed chamber 34 to lift the spool 4 from the seat member 31 against the biasing force of the spool-return spring 5.

Here, it is conceived that only a minute rough clearance 100, which is defined by roughness of the seated surfaces of the spool 4 and the seat member 31, may be employed as a small communication unit. However, when only the rough clearance 100 is employed, the amount of oil flowing into the bleed chamber 34 through the rough clearance 100 may be insufficient. Consequently, the hydraulic pressure in the bleed chamber 34 sluggishly increases to hydraulic pressure, at which the spool 4 is lifted. Thus, response of the spool 4 when being lifted from the seat member 31 may be degraded.

As shown in FIGS. 6A, 6B, U.S. Pat. No. 6,615,869 B2 discloses a small orifice 101 as the small communication unit. The small orifice 101 is a small groove provided in the seat-side seated surface 62 to communicate the supply port 12 with the bleed chamber 34. In the structure of FIGS. 6A, 6B, even when the spool 4 is seated to the seat member 31, the bleed chamber 34 is supplied with oil from the supply port 12 through the small orifice 101.

The amount oil flowing into the bleed chamber 34 through the small orifice 101 can be increased by enlarging the passage area of the small orifice 101. Thus, hydraulic pressure in the bleed chamber 34 can be quickly increased to the hydraulic pressure, at which the spool 4 is lifted. Consequently, response of the spool 4 when being lifted from the seat member 31 can be enhanced. However, when the spool 4 is seated to the seat member 31, the valve 32 opens the bleed port 35. Therefore, when the passage area of the small orifice 101 is enlarged, the amount of oil leaking from the small orifice 101 to the low-pressure component through the bleed chamber 34 increases. That is, the response of the spool 4 can be enhanced by enlarging the passage area of the small orifice 101, nevertheless the leakage of oil through the small orifice 101 when the spool 4 is seated to the seat member 31 increases. In particular, the leakage of oil under high-temperature condition may increase.

That is, the response when the spool 4 is lifted from the seat member 31 and the leakage of oil when the spool 4 is seated to the seat member 31 are in conflict. For satisfying the response and suppressing the leakage within a suitable limit, it suffices that the small orifice 101 has a very minute groove even in consideration of the response under a low temperature condition. However, it is difficult to manufacture a microscopic groove properly to serve as the small orifice 101 accurately. Actually, a manufacturable small slit may be provided. However, in this case, leakage may become large under a high-temperature condition.

### SUMMARY OF THE INVENTION

In view of the foregoing and other problems, it is an object of the present invention to produce a bleed valve apparatus, which is capable of satisfying both response and reduction in leakage of oil.

According to one aspect of the present invention, a bleed valve apparatus comprises a valve body having a sliding hole, which axially extends. The bleed valve apparatus further comprises a spool axially movable in the sliding hole. The bleed valve apparatus further comprises a seat member having a bleed port, the seat member and the spool defining a bleed chamber. The bleed valve apparatus further comprises an open-close unit configured to open and close the bleed port to control communication between the bleed chamber and a low-pressure component through the bleed port. The spool has a spool end surface, which is located at the side of the seat member. The seat member has a seated surface, to which the spool is configured to be seated. The spool is configured to substantially blockade a supply port, which is for supplying fluid to the bleed chamber, from the bleed chamber by being seated to the seat member. The spool end surface of the spool and the seated surface of the seat member are inclined with respect to each other to therebetween define an inclination clearance, which is configured to communicate the supply port with the bleed chamber when the spool is seated to the seat member.

### BRIEF DESCRIPTION OF THE DRAWINGS

The above and other objects, features and advantages of the present invention will become more apparent from the following detailed description made with reference to the accompanying drawings. In the drawings:

FIG. 1 is a lateral sectional view showing a solenoid hydraulic pressure control valve according to a first embodiment;

FIG. 2 is a lateral sectional view showing a solenoid hydraulic pressure control valve according to a second embodiment;

FIG. 3 is a lateral sectional view showing a solenoid hydraulic pressure control valve according to a third embodiment;

FIG. 4 is a lateral sectional view showing a solenoid hydraulic pressure control valve according to a fourth embodiment;

FIG. 5 is a lateral sectional view showing a solenoid hydraulic pressure control valve according to a prior art; and

FIG. 6A is a front view showing a seat member when being viewed along the axis of the seat member, and FIG. 6B is a lateral sectional view showing the seat member according to the prior art.

### DETAILED DESCRIPTION OF PREFERRED EMBODIMENTS

### First Embodiment

As follows, a bleed valve device will be described. According to the first embodiment, the bleed valve device is applied to a solenoid hydraulic pressure control valve. In the first embodiment, a basic structure of the solenoid hydraulic pressure control valve is first described.

(Basic Structure of Solenoid Hydraulic Pressure Control Valve)

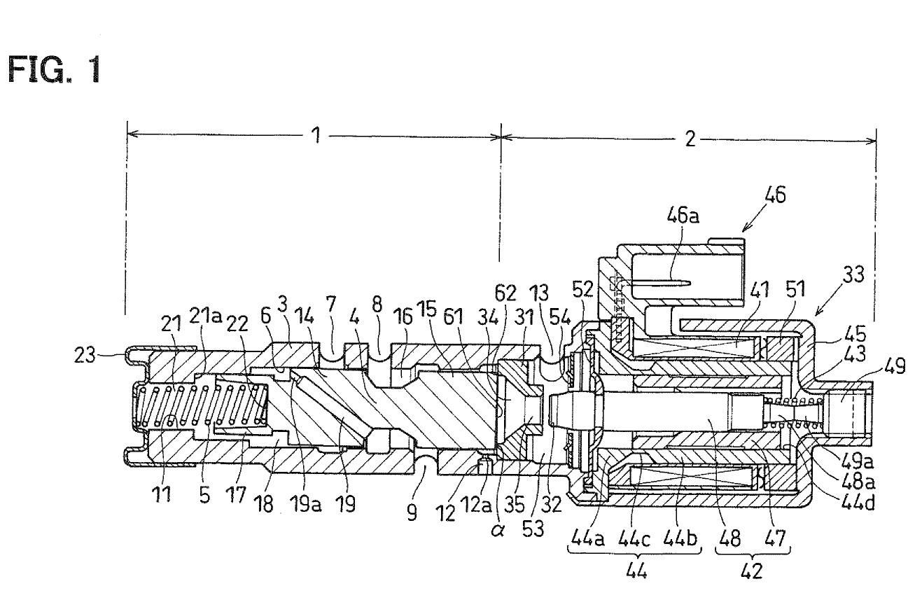

As shown in FIG. 1, for example, the solenoid hydraulic pressure control valve is mounted to the hydraulic pressure control device of an automatic transmission device. The solenoid hydraulic pressure control valve is constructed by combining a spool valve 1 with an electromagnetic bleed valve (solenoid bleed valve) 2. The spool valve 1 as a hydraulic pressure control valve performs switching and controlling of hydraulic pressure. The electromagnetic bleed valve 2 actuates the spool valve 1.

A solenoid actuator 33 is a part of the solenoid bleed valve 2. According to the first embodiment, the solenoid hydraulic pressure control valve has a normally-Low (N/L) output structure. Specifically, the bleed port 35 is at the maximum opening when the solenoid actuator 33 is turned OFF. In the present condition where the solenoid actuator 33 is turned OFF, the input port 7 and the output port 8 are at minimum communication therebetween, and the output port 8 and an exhaust port 9 are at maximum communication therebetween. That is, the input port 7 is substantially blockaded from the output port 8, and the output port 8 is communicated with the exhaust port 9.

(Description of Spool Valve 1)

A spool valve 1 includes a sleeve 3, a spool 4, and a spool-return spring 5.

The sleeve 3 is inserted into a case of an unillustrated hydraulic controller. The sleeve 3 is in a substantially cylindrical shape. The sleeve 3 has an insertion hole 6, an inlet port 7, an outlet port 8, and an exhaust port 9. The insertion hole 6 holds the spool 4 such that the spool 4 is slidable axially relative to the insertion hole 6. The input port 7 is communicated with an oil outlet port of an oil pump as a hydraulic pressure generating unit through a passage or the like and applied with input hydraulic pressure from oil, which is supplied from the oil pump. The output port 8 applies output hydraulic pressure, which is regulated in the spool valve 1. The exhaust port 9 is communicated with a low-pressure side, at which a low-pressure component such as an oil sump is provided.

The sleeve 3 has the left end in FIG. 1, and the left end has a spring insertion hole 11 through which the spool-return spring 5 is inserted into the sleeve 3. The oil ports including the input port 7, the output port 8, and the exhaust port 9 are through holes, which are provided in the lateral side of the sleeve 3. Specifically the input port 7, the output port 8, the exhaust port 9, a supply port 12, and a bleed exhaust port 13 are provided on the lateral side of the sleeve 3 and arranged in order from the left to the right in FIG. 1. The bleed chamber 34 is supplied with oil through the supply port 12. The bleed chamber 34 bleeds oil to a low-pressure component outside of the sleeve 3 through the bleed exhaust port 13.

The supply port 12 is provided with a control orifice 12a for regulating the maximum flow of oil that passes through the supply port 12, thereby regulating consumption of oil when a valve 32 is opened. The supply port 12 communicates with the input port 7 through a pressure regulator valve at the outside of the sleeve 3 within the unillustrated hydraulic pressure controller. The exhaust port 9 communicates with the bleed exhaust port 13 at the outside of the sleeve 3 within the hydraulic pressure controller.

The spool 4 is slidable in the sleeve 3, and includes an input seal land 14 and an exhaust seal land 15. The input seal land 14 is capable of blockading the input port 7. The exhaust seal land 15 is capable of blockading the exhaust port 9. The input seal land 14 and the exhaust seal land 15 have a distribution chamber 16 therebetween. The spool 4 has a feedback land 17 at the left side of the input seal land 14 in FIG. 1. The feedback land 17 is smaller than the input seal land 14 in diameter. The input seal land 14 and the feedback land 17 therebetween have a land difference (difference in diameter) and define a feedback chamber 18. The spool 4 therein has a feedback port 19, which communicates the distribution chamber 16 with the feedback chamber 18 to generate F/B hydraulic pressure in the feedback chamber 18 according to the output pressure. The feedback port 19 is provided with a feedback orifice 19a to suitably generate F/B hydraulic pressure in the feedback chamber 18.

In the present structure, as hydraulic pressure (outlet pressure) in the feedback chamber 18 becomes greater, differential pressure applied to the spool 4 becomes greater in accordance with the difference (land difference) between the inlet seal land 14 and the feedback land 17. Thus, axial force is applied to the spool 4 to displace the spool 4 toward the right in FIG. 1. In this operation, the movement of the spool 4 is stabilized, so that outlet pressure can be stabilized regardless of variation in inlet pressure. The spool 4 is maintained at a position where the spring force of the spool-return spring 5, the driving force, which is generated by pressure in the bleed chamber 34 and applied to the spool 4, and the axial force applied to the spool 4 correspondingly to the land difference between the inlet seal land 14 and the feedback land 17 balance thereamong.

The spool-return spring 5 as a biasing member is a coil spring being in a cylindrical helical spring. In this embodiment, the spool-return spring 5 biases the spool 4 toward a valve closing side on the right side in FIG. 1, such that the length (inlet seal length) of the seal in the inlet becomes large to decrease the outlet pressure. The spool-return spring 5 is in contact with the bottom surface of a recess 22 at one end. The recess 22 is provided in the feedback land 17. The spool-return spring 5 is held by being in contact with the bottom surface of a spring seat 23 at the other end. The spring seat 23 is fixed to the left end of the sleeve 3 in FIG. 1 by being welded, caulked, or the like. A spring chamber 21 has a step 21a, which determines the maximum open position as a maximum lift position of the spool 4 by making contact with the left end of the spool 4 in FIG. 1.

(Description of Solenoid Bleed Valve 2)

The solenoid bleed valve 2 is configured to actuate the spool 4 to the left in FIG. 1 according to pressure in the bleed chamber 34, which is provided at the right side of the spool 4 in FIG. 1. The solenoid bleed valve 2 is constructed of a seat member 31 and the solenoid actuator 331 which is provided with the valve 32. The seat member 31 is substantially in a ring shape and fixed inside the sleeve 3 at the right side in FIG. 1. The seat member 31 and the spool 4 therebetween define the bleed chamber 34 to actuate the spool 4. The seat member 31 has a center portion, which has a bleed port 35. The bleed port 35 is configured to communicate the bleed chamber 34 with the bleed exhaust port 13 at low-pressure.

The seat member 31 has the end surface on the left side in FIG. 1 and the end surface is configured to be seated with the spool 4, thereby determining the maximum close position as a spool seated position of the spool 4. The seat member 31 has the end surface at the right side in FIG. 1, and the end surface is configured to make contact with the valve 32, which is provided in the axial end of a shaft 48. The valve 32 is configured to make contact with the end surface of the seat member 31 at the right side in FIG. 1, thereby blockading the bleed port 35.

The solenoid actuator 33 includes a coil 41, a movable element 42, a return spring 43 for the movable element 42, a stator 44, a yoke 45, and a connector 46. The solenoid actuator 33 is configured to actuate the valve 32 so as to control communication through the bleed port 35. When the valve 32 decreases communication through the bleed port 35, pressure in the bleed chamber 34 increases, whereby the spool 4 is displaced in the opening direction to the left in FIG. 1. Conversely, when the valve 32 increases communication through the bleed port 35, pressure in the bleed chamber 34 decreases, whereby the spool 4 is displaced in the closing direction to the right in FIG. 1.

The coil 41 is configured to generate magnetism when being energized, thereby forming a magnetic flux loop, which passes through the movable element 42 (the moving core 47) and a magnetism stator, which includes the stator 44 and the yoke 45. The coil 41 is constructed by winding a wire, which is coated with an insulative material, around the circumference of a resin bobbin. The movable element 42 includes a moving core 47 and the shaft 48. The moving core 47 is in a cylindrical shape and magnetically attracted by the magnetism, which the coil 41 axially generates. The shaft 48 is press-fitted into the moving core 47 and provided with the valve 32 at the axial end. The moving core 47 is formed of a magnetic metal such as iron to be substantially in an annular column shape for defining the magnetic circuit. The moving core 47 is directly slidable on the inner periphery of the stator 44. The shaft 48 is formed from a nonmagnetic material, such as stainless steel, being high in hardness. The shaft 48 is substantially in a stick shape and press-fitted to be fixed to the moving core 47. The shaft 48 is provided with the valve 32 at the left end in FIG. 1 to open and close the bleed port 35.

The return spring 43 is a coil spring, which is formed by winding a wire to be in a cylindrical shape to bias the shaft 48 in the closing direction such that the valve 32 closes the bleed port 35. The return spring 43 is maintained in a state where being compressed between the end of the shaft 48 at the right side in FIG. 1 and an adjuster (adjusting screw) 49. The adjuster 49 is axially screwed into the center portion of the yoke 45. In the solenoid bleed valve 2 according to the present first embodiment, when the solenoid actuator 33 is turned OFF and the moving core 47 is not applied with magnetism, which is directed to the left in FIG. 1, the valve 32 moves to the right side in FIG. 1 by being applied with exhaust pressure of oil from the bleed port 35, thereby opening the bleed port 35. The return spring 43 is configured to apply biasing force to the movable element 42 for controlling a characteristic of the movable element 42. Specifically, the return spring 43 exerts spring force such that the shaft 48 can be moved to the right in FIG. 1 by being applied with exhaust pressure of the oil from the bleed port 35 when the solenoid actuator 33 is turned OFF. The spring load of the return spring 43 is adjusted according to a length by which the adjuster 49 is screwed.

The right end of the shaft 48 in FIG. 1 is provided with a shaft-end projected portion 48a, which extends to the right in FIG. 1 inside the return spring 43. The left end of the adjuster 49 in FIG. 1 is provided with an adjuster-end projected portion 49a, which extends to the left in FIG. 1 inside the return spring 43. The shaft-end projected portion 48a and the adjuster-end projected portion 49a makes contact with each other when the shaft 48 is displaced to the right in FIG. 1.

The stator 44 is made from a magnetic metallic material such as iron. In particular, the stator 44 is made from ferromagnetic material, which configures a magnetic circuit. The stator 44 includes an attracting stator 44a and a slidable stator 44b. The stator 44 has a magnetism saturation groove 44c. The attracting stator 44a magnetically attracts the moving core 47 in the axial direction toward the left side in FIG. 1 in the direction, in which the valve 32 closes the bleed port 35. The slidable stator 44b surrounds the circumference of the moving core 47 and transmits the magnetic flux to the moving core 47 in the radial direction. The magnetism saturation groove 44c is a portion in which magnetic resistance becomes large. The magnetism saturation groove 44c suppresses the magnetic flux passing between the attracting stator 44a and the slidable stator 44b, thereby leading the magnetic flux through the attracting stator 44a, the moving core 47, and the slidable stator 44b in order. The inner circumferential periphery of the stator 44 defines an axial hole 44d, which supports the moving core 47 such that the moving core 47 is slidable therein. The axial hole 44d is a through hole substantially uniform in inner diameter from one end of the stator 44 toward the other end of the stator 44.

The attracting stator 44a is magnetically joined with the yoke 45 via a flange, which is axially interposed between the yoke 45 and the sleeve 3. The attracting stator 44a includes a cylindrical portion, which axially overlaps with the moving core 47 when attracting the moving core 47. The cylindrical portion has the circumferential periphery, which is in a tapered shape such that magnetic attractive force does not change accompanied with change in the stroke of the moving core 47.

The slidable stator 44b is substantially in a cylindrical shape and entirely surrounds the circumferential periphery of the moving core 47. A magnetism transmission ring 51 is provided on the outer circumferential periphery of the slidable stator 44b. The magnetism transmission ring 51 is formed from a magnetic material such as iron. In particular, the magnetism transmission ring 51 is formed from a ferromagnetic material, which configures a magnetic circuit. In the present structure, the slidable stator 44b and the yoke 45 are magnetically joined. The slidable stator 44b is configured to support the moving core 47 inside the axial hole 44d such that the moving core 47 is axially slidable directly on the slidable stator 44b. The slidable stator 44b also transmits the magnetic flux with the moving core 47 in the radial direction. The yoke 45 is formed of a magnetic metallic material such as iron to be substantially in a cup shape to surround the coil 41. In particular, the yoke 45 is formed from a ferromagnetic material, which configures a magnetic circuit. The yoke 45 is firmly joined with the sleeve 3 by crimping a claw portion, which is provided in the open end thereof.

The sleeve 3 is connected with the yoke 45 via a connecting portion, which is provided with a diaphragm 52 for partitioning the interior of the sleeve 3 from the interior of the solenoid actuator 33. The diaphragm 52 is formed from rubber to be substantially in a ring shape. The diaphragm 52 has an outer circumferential portion interposed between the sleeve 3 and the stator 44. The diaphragm 52 has a center portion fitted to a groove, which is formed in the outer circumferential periphery of the shaft 48. In the present structure, the diaphragm 52 protects the solenoid actuator 33 from intrusion of oil and foreign matters from an exhaust-oil-pressure chamber 53 in the sleeve 3. The exhaust-oil-pressure chamber 53 is provided in the sleeve 3 on the right side in FIG. 1. The exhaust-oil-pressure chamber 53 is partitioned by the seat member 31 and the diaphragm 52. The exhaust-oil-pressure chamber 53 communicates with the bleed exhaust port 13. A pressure shield 54 is substantially in a ring shaped plate and provided at the side of the exhaust-oil-pressure chamber 53 with respect to the diaphragm 52 to restrict pressure in the exhaust-oil-pressure chamber 53 from being directly applied to the diaphragm 52.

The connector 46 electrically connects with an electronic control unit (not shown) via a lead wire. The electronic control unit is for controlling the solenoid hydraulic pressure control valve. The connector 46 accommodates a terminal 46a, which is connected with both ends of the coil 41. The electronic control unit is configured to perform a duty-ratio control of an electric current supplied to the coil 41 of the solenoid actuator 33. Whereby, the electronic control unit linearly manipulates the axial position of the movable element 42, which includes the moving core 47 and the shaft 48, against the exhaust pressure of oil in the bleed port 35 by manipulating the electric current supplied to the coil 41. In such a manner, the electronic control unit manipulates the axial position of the valve 32 by changing the axial position of the movable element 42 so as to control the lift of the bleed port 35. Thus, the electronic control unit controls the hydraulic pressure in the bleed chamber 34.

In the present structure, the electronic control unit controls the hydraulic pressure in the bleed chamber 34, thereby manipulating the axial position of the spool 4. Thus, the ratio between an input side seal length and an exhaust side seal length is controlled. Here, the input side seal length is defined by the input seal land 14 and associated with communication between the input port 7 and the distribution chamber 16. The exhaust side seal length is defined by the exhaust seal land 15 and associated with communication between the distribution chamber 16 and the exhaust port 9. Consequently, the output hydraulic pressure in the output port 8 is controlled.

### Feature of First Embodiment

The seat member 31 is an annular member and has the bleed chamber 34 therein. The end surface of the seat member 31 at the left side in FIG. 1 defines an annular seat-side seated surface 62, to which the spool 4 is seated. When the spool 4 is seated to the seat-side seated surface 62 of the seat member 31, the supply port 12 is blockaded from the bleed chamber 34 by the spool 4. Thus, consumption of oil exhausted through the supply port 12, the bleed chamber 34, and the bleed port 35 in order is restricted.

If the supply port 12 is completely blockaded from the bleed chamber 34 in a condition where the spool 4 is seated to the seat member 31, oil cannot be supplied to the bleed chamber 34. In this condition, even when the bleed port 35 is blockaded by the valve 32, hydraulic pressure does not occur in the bleed chamber 34. Therefore, in the present structure, a small communication unit is provided to lead oil from the supply port 12 to the bleed chamber 34 even when the spool 4 is seated to the seat member 31.

### Background of First Embodiment

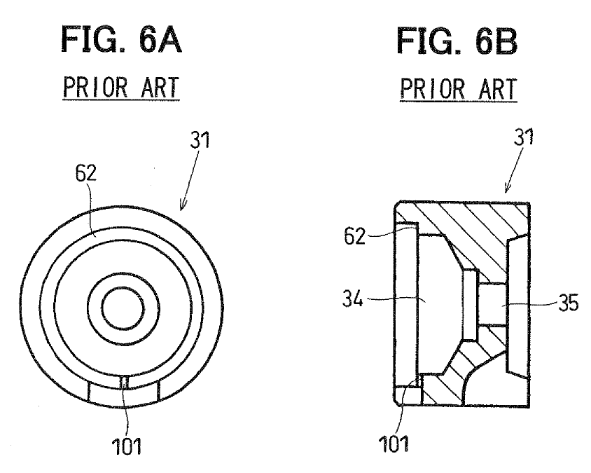

Conventionally, referring to FIGS. 6A, 6B, a small orifice 101 is used as a small communication unit. The small orifice 101 has a fine groove in the seat-side seated surface 62. Oil flowing into the bleed chamber 34 through the small orifice 101 can be increased by enlarging the passage area of the small orifice 101. Thus, hydraulic pressure in the bleed chamber 34 can be quickly increased to the lift hydraulic pressure. Consequently, response of the spool 4 when being lifted from the seat member 31 can be enhanced.

However, when the spool 4 is seated to the seat member 31, the valve 32 opens the bleed port 35. Therefore, when the passage area of the small orifice 101 is enlarged, an exhaust amount of oil leaking from the small orifice 101 to the low-pressure component through the bleed chamber 34 increases. Even in consideration of the response under a low temperature condition, a fine slit as a very thin groove suffices to serve as the small orifice 101 (FIG. 6A) for satisfying the response and the amount of leakage within a suitable limit. However, it is difficult to accurately manufacture a microscopic slit properly to serve as the small orifice 101. A manufacturable small slit may be actually provided. However, in this case, leakage amount may become large under a high-temperature condition.

(Structure for Solving the Problem)

In order to solve the defect, according to the present first embodiment, the conventional small orifice 101, which is provided in the seat member 31, is omitted. As an alternative, a small communication unit shown below is employed. According to the present first embodiment, a spool end surface 61 of the spool 4 and the seat-side seated surface 62 of the seat member 31 therebetween define an inclination clearance α as the small communication unit. The inclination clearance α is a minute clearance, which is defined by inclination of the surface and configured to lead oil from the supply port 12 to the bleed chamber 34 through the inclination clearance α.

Specifically, according to the present first embodiment, as shown in FIG. 1, offset load is exerted from the spool-return spring 5 to the spool 4. By exerting the offset load, the axis of the spool 4 is inclined with respect to the axis of the sliding hole 6, thereby inclining the spool end surface 61 so as to define the inclination clearance α between the spool end surface 61 and the seat-side seated surface 62.

The present structure is described further in detail. Since the sleeve 3 and the spool 4 therebetween define the slidable clearance, the spool 4 can be inclined by the slidable clearance inside the sliding hole 6. Here, the spool end surface 61 is perpendicular to the axis of the spool 4.

On the other hand, the seat-side seated surface 62 is perpendicular to the axis of the seat member 31. Therefore, even in a condition where the seat member 31 is mounted inside the sleeve 3, the seat-side seated surface 62 is perpendicular to the axis of the sleeve 3. In the present structure, the inclination clearance α is defined between the spool end surface 61 and the seat-side seated surface 62 when the spool 4, which is inclined inside the sleeve 3, is seated to the seat member 31.

For example, the spool end surface 61 may have a circular periphery, and the seated surface 62 may have a circular periphery. in this case, the circular periphery of the spool end surface 61 and the circular periphery of the seated surface 62 therebetween define the small communication unit a with respect to the circumferential direction to regularly communicate the supply port 12 with the bleed chamber 34.

In FIG. 1, the slidable clearance and the inclination of the spool 4 are depicted large to be remarkable in order to explain the inclination of the spool 4 and the inclination clearance α.

As described above, according to the present first embodiment, the spool-return spring 5 is the compression coil spring. The compression coil spring is configured to exert offset load itself. In particular, according to the present first embodiment, the spool-return spring 5 is configured to exert the offset load to incline the spool 4 inside the sliding hole 6 even when the spool 4 is seated to the seat member 31. Here, the spool-return spring 5 itself may be configured to exert the offset load sufficiently to incline the spool 4. Alternatively, the support face of the axial end of the spool-return spring 5 may be inclined, or a step may be provided on the axial end of the spool-return spring 5. Even in these structures, the spool-return spring 5 may be configured to exert large offset load sufficiently to incline the spool 4 in a state where the spool 4 is seated to the seat member 31 inside the sliding hole 6.

### Operation of First Embodiment

Next, an operation of the solenoid hydraulic pressure control valve is described. In a state where energization of the solenoid actuator 33 is stopped, the valve 32 is biased to the right in FIG. 1 by being applied with the exhaust pressure of oil from the bleed port 35. Therefore, the movable element 42, which includes the moving core 47 and the shaft 48, is displaced to the right in FIG. 1, whereby the opening of the bleed port 35 is enlarged. Thus, the bleed chamber 34 is in a pressure-exhausting state to release pressure therefrom, thereby the spool 4 is seated to the seat member 31 and stopped at the maximum close position as a spool seated position. In the present condition, when the spool 4 stops at the maximum close position, communication between the input port 7 and the output port 8 becomes minimum, whereby the input port 7 is blockaded from the output port 8. In addition, in the present condition, communication between the output port 8 and the exhaust port 9 becomes maximum, whereby the output port 8 is in the pressure-exhausting state to release pressure therethrough.

When a driving current is supplied to the solenoid actuator 33, which is being de-energized, the magnetic attractive force is exerted to move the moving core 47 to the left in FIG. 1. Thus, the movable element 42, which includes the moving core 47 and the shaft 48, is displaced to the left in FIG. 1, whereby the opening of the bleed port 35 is reduced. Then, the amount of oil, which is exhausted from the bleed port 35 exceeds the amount of oil, which is supplied to the bleed chamber 34 through the inclination clearance α as the small communication unit defined between the spool end surface 61 and the seat-side seated surface 62. Thus, the hydraulic pressure in the bleed chamber 34 increases. When the hydraulic pressure in the bleed chamber 34 reaches the lift hydraulic pressure, the spool 4 is lifted from the seat member 31. When the spool 4 is lifted from the seat member 31, the clearance between the spool end surface 61 and the seat-side seated surface 62 is enlarged. Whereby, the amount of oil flowing into the bleed chamber 34 through the supply port 12 increases.

As the driving current is further supplied to the solenoid actuator 33, the opening of the bleed port 35 becomes small. Consequently, pressure in the bleed chamber 34 increases, whereby the spool 4 is moved to the left in FIG. 1 against the biasing force of the spool-return spring 5. That is, as the driving current supplied to the solenoid actuator 33 increases, the communication between the output port 8 and the exhaust port 9 decreases, and the communication between the input port 7 and the output port 8 increases. Whereby, the pressure in the output port 8 increases.

When the valve 32 makes contact with the seat member 31 to blockade the bleed port 35 accompanied with further increase in driving current supplied to the solenoid actuator 33, pressure in the bleed chamber 34 becomes maximum by being supplied with oil from the supply port 12. Thus, the spool 4 is further moved to the left in FIG. 1 against the biasing force of the spool-return spring 5. In the present condition, the communication between the input port 7 and the output port 8 becomes maximum, and the communication between the output port 8 and the exhaust port 9 becomes minimum, that is, the output port 8 is blockaded from the exhaust port 9. Thus, the output pressure in the output port 8 becomes maximum.

The spool 4 is positioned at the balanced position in the state of the present maximum output. Specifically, The spool 4 is positioned at an axial position, in which the pressure applied from the bleed chamber 34 to the right end surface of the spool 4 in FIG. 1, the spring load of the spool-return spring 5, and the axial force generated by the feedback operation when the maximum output pressure as the input pressure is applied to the feedback chamber 18. In general, the balanced position of the spool 4 at the time of the maximum output is at the right side of the maximum open position of the spool 4 (spool maximum lift position) illustrated in FIG. 1. At the balanced position, the spool 4 is not in contact with the step 21a of the spring chamber 21.

An operation contrary to the above operation is performed when the driving current of the solenoid actuator 33 decreases. In this case, when energization of the solenoid actuator 33 is stopped, the spool 4 is seated to the seat member 31 again and positioned at the maximum close position (spool seated position).

### Effect of First Embodiment

In the solenoid hydraulic pressure control valve according to the first embodiment, the inclination clearance α is provided between the spool end surface 61 of the spool 4 and the seat-side seated surface 62 of the seat member 31. By defining the inclination clearance α, oil can be supplied from the supply port 12 to the bleed chamber 34 even when the spool 4 is seated to the seat member 31. Thus, hydraulic pressure can be generated in the bleed chamber 34 to drive the spool 4 in a condition where the bleed port 35 is blockaded by the solenoid actuator 33. Thus, according to the present first embodiment, the small orifice 101, which requires high accuracy sufficient to produce response and suppress the leakage amount, can be omitted. Whereby, a manufacturing cost can be reduced. In addition, the angle of the inclination clearance α, which is defined between the spool end surface 61 and the seat-side seated surface 62, and the seal length at the portion defining the inclination clearance α with respect to the radial direction may be adjusted. By adjusting the angle of the inclination clearance α and the seal length, communication between the supply port 12 and the bleed chamber 34 can be controlled when the spool 4 is seated to the seat member 31 Thus, the leakage amount can be suitably regulated while the response is maintained.

### Second Embodiment

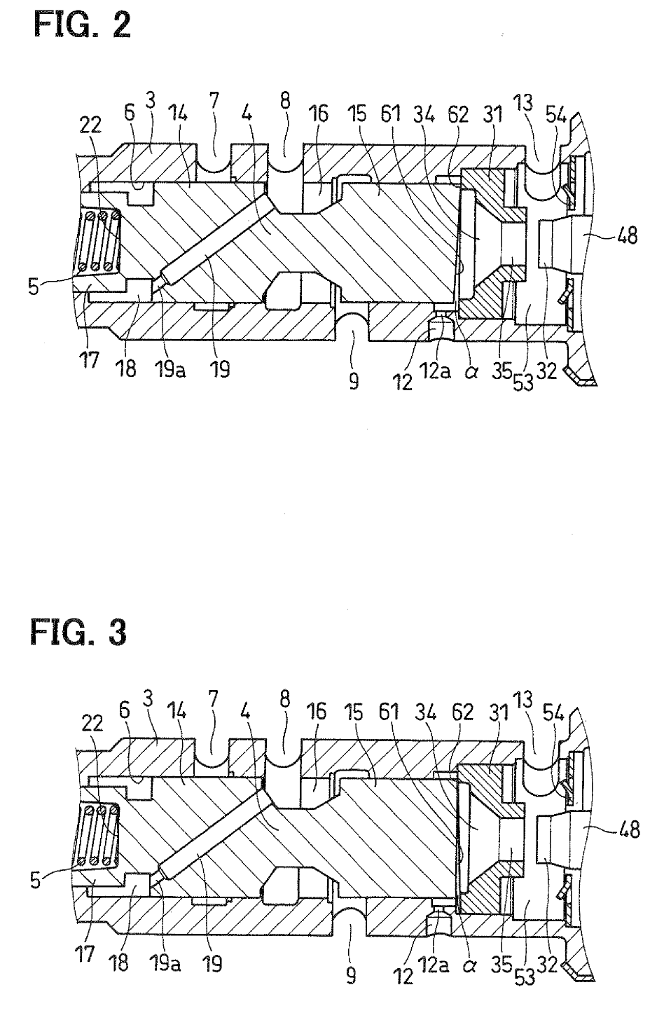

The second embodiment is described with reference to FIG. 2. In the first embodiment, the inclination clearance α is defined between the spool end surface 61 and the seat-side seated surface 62 by inclining the spool 4 in the sleeve 3. According to the present second embodiment, the inclination clearance α is provided between the spool end surface 61 and the seat-side seated surface 62 by inclining the spool end surface 61 of the spool 4 with respect to the seat-side seated surface 62.

Specifically according to the present second embodiment, the spool 4 is not seated to the seat member 31 in a state where the spool 4 is entirely inclined with respect to the sleeve 3. The spool end surface 61 of the spool 4 is slightly inclined with respect to the surface, which is perpendicular to the axis of the spool 4. On the other hand, the seat-side seated surface 62 of the seat member 31 is perpendicular to the axis of the sleeve 3. In the present structure, the inclination clearance α is defined between the spool end surface 61 and the seat-side seated surface 62 when the spool 4 is seated to the seat member 31. In the present structure, an advantage similar to that of the first embodiment can be produced.

The spool end surface 61 may define the entire slope. Alternatively, the spool end surface 61 may partially define the slope. For example, one side of the spool end surface 61 may partially define the slope. In the present structure, the seal length with respect to the radial direction around the inclination clearance α can be controlled by modifying the slope. Thus, the communication between the supply port 12 and the bleed chamber 34 when the spool 4 is seated to the seat member 31 can be controlled.

### Third Embodiment

The third embodiment is described with reference to FIG. 3. In the second embodiment, the inclination clearance α is defined between the spool end surface 61 and the seat-side seated surface 62 by inclining the spool end surface 61 in the spool 4. According to the present third embodiment, the inclination clearance α is defined between the spool end surface 61 and the seat-side seated surface 62 by inclining the seat-side seated surface 62 of the seat member 31 with respect to the spool end surface 61.

Specifically according to the present third embodiment, the spool 4 is not seated to the seat member 31 in a state where the spool 4 is inclined with respect to the sleeve 3, similarly to the second embodiment. The seat-side seated surface 62 of the seat member 31 is slightly inclined with respect to the surface perpendicular to the axis of the sleeve 3. Here, the spool end surface 61 is perpendicular to the axis of the spool 4. In the present structure, the inclination clearance α is defined between the spool end surface 61 and the seat-side seated surface 62 when the spool 4 is seated to the seat member 31. In this structure, an advantage similar to that of the first embodiment can be produced.

The seat-side seated surface 62 may define the entire slope. Alternatively, the seat-side seated surface 62 may partially define the slope. For example, one side of the seat-side seated surface 62 may partially define the slope. In the present structure, the seal length with respect to the radial direction around the inclination clearance α can be controlled by modifying the slope. Thus, the communication between the supply port 12 and the bleed chamber 34 when the spool 4 is seated to the seat member 31 can be controlled.

### Fourth Embodiment

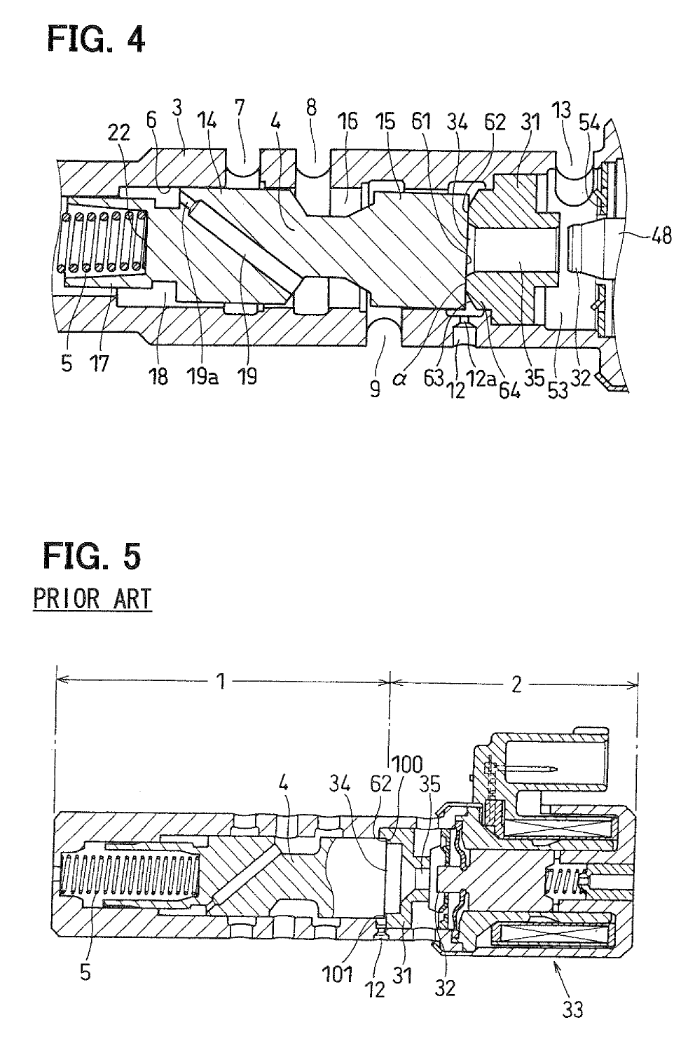

The fourth embodiment is described with reference to FIG. 4. In the solenoid hydraulic pressure control valve according to the present fourth embodiment, the seat member 31 has a small-diameter contact area unit, in which the outer diameter of the contact area of the seat-side seated surface 62 is reduced. Specifically, the small-diameter contact area unit is a tapered portion 63, which has a tapered surface reduced in diameter toward the spool 4. The tapered portion 63 is configured to reduce the outer diameter of the contact area of the seat-side seated surface 62. In the present structure, the diameter of the contact area of the seat-side seated surface 62 is reduced by providing the tapered portion 63 as one example of the small-diameter contact area unit. Whereby, the seal length with respect to the radial direction around the inclination clearance α can be shortened. Thus, the communication between the supply port 12 and the bleed chamber 34 when the spool 4 is seated to the seat member 31 can be controlled. In the present fourth embodiment, the tapered portion 63 is shown as one example of the small-diameter contact area unit. Alternatively, the tapered surface may be replaced with a stepped surface to reduce the diameter of the contact area of the seat-side seated surface 62.

According to the present fourth embodiment, the tapered portion 63 is provided in the seat member 31. Specifically, the tapered portion 63 is provided in an axial extension portion 64, which extends toward the spool 4. In the present structure, the seat-side seated surface 62 is located further close to the spool 4. The axial extension portion 64 is configured to coincide the axial position of the seat-side seated surface 62 with the axial position of the supply port 12. In the present structure, the supply port 12 is located close to the portion defining the inclination clearance α between the spoof end surface 61 and the seat-side seated surface 62. Therefore, oil can be smoothly led from the supply port 12 to the portion defining the inclination clearance α even when viscosity of oil is large under a low temperature condition. Thus, the response can be enhanced under a low temperature condition. The present fourth embodiment is described with reference to FIG. 4 in which the tapered portion 63 is provided to the structure of the first embodiment. Alternatively, the tapered portion 63 may be combined with any one of the structures according to the second embodiment and the third embodiment.

### MODIFICATION

According to the above embodiments, the solenoid hydraulic pressure control valve has the normally-Low (N/L) output structure. Alternatively, the solenoid hydraulic pressure control valve may have a normally-High (N/H) output structure, in which communication between the input port 7 and the output port 8 becomes maximum when the solenoid actuator 33 is turned OFF.

According to the above embodiments, the spool valve 1 is a three-way valve. However, the spool valve 1 is not limited to the three-way valve. The spool valve 1 may be a two-way valve (ON OFF valve) or a four-way valve, for example.

According to the above embodiments, the solenoid actuator 33 (valve 32) is employed as one example of an open-close unit. Alternatively, other electric actuators such as an electric motor or a piezo actuator, which includes a piezo stack, may be employed as the open-close unit.

According to the above embodiments, the hydraulic pressure control valve having the present structure is used for the automatic transmission device. Alternatively, the present hydraulic pressure control valve may be applied to other devices than an automatic transmission device.

According to the above embodiments, the present characterized structure is applied to the hydraulic pressure control valve. Alternatively, the present characterized structure may be applied to an oil flow control valve (OCV) for controlling an oil flow.

The hydraulic fluid is not limited to oil.

The above structures of the embodiments can be arbitrary combined. Various modifications and alternations may be diversely made to the above embodiments without departing from the spirit of the present invention.

What is claimed is:

1. A bleed valve apparatus comprising:
a valve body having a sliding hole, which axially extends;
a spool axially movable in the sliding hole;
a seat member having a bleed port, the seat member and the spool defining a bleed chamber; and
an open-close unit configured to open and close the bleed port to control communication between the bleed chamber and a low-pressure component through the bleed port,
wherein the spool has a spool end surface, which is located at the side of the seat member,
the seat member has a seated surface, to which the spool is configured to be seated,
the spool is configured to substantially blockade a supply port, which is for supplying fluid to the bleed chamber from the bleed chamber by being seated to the seat member, and
the spool end surface of the spool and the seated surface of the seat member are inclined with respect to each other to therebetween define an inclination clearance, which is configured to communicate the supply port with the bleed chamber when the spool is seated to the seat member.

2. The bleed valve apparatus according to claim 1, further comprising:
a biasing member for biasing the spool to the seat member,
wherein the biasing member is configured to incline an axis of the spool with respect to an axis of the sliding hole by exerting offset load to the spool, thereby defining the inclination clearance between the spool end surface and the seated surface.

3. The bleed valve apparatus according to claim 1, wherein the spool end surface is inclined with respect to the seated surface, thereby defining the inclination clearance between the spool end surface and the seated surface.

4. The bleed valve apparatus according to claim 1, wherein the seated surface is inclined with respect to the spool end surface, thereby defining the inclination clearance between the spool end surface and the seated surface.

5. The bleed valve apparatus according to claim 1, wherein the seat member has a small-diameter contact area unit, which reduces a diameter of a contact area of the seated surface.

6. The bleed valve apparatus according to claim 5,
wherein the small-diameter contact area unit is a tapered portion, which is reduced in diameter toward the spool,
the seat member has an axial extension portion by which the seated surface is located close to the supply port, and
the tapered portion is provided in the axial extension portion.

7. The bleed valve apparatus according to claim 1,
wherein the valve body has an exhaust port through which the bleed port is configured to communicate with the low-pressure component, and
the low-pressure component is located outside of the valve body.

8. The bleed valve apparatus according to claim 1, wherein the valve body has the supply port.

9. The bleed valve apparatus according to claim 1,
wherein the spool end surface has a circular periphery,
the seated surface has a circular periphery, and
the circular periphery of the spool end surface and the circular periphery of the seated surface therebetween define the small communication unit with respect to a circumferential direction to regularly communicate the supply port with the bleed chamber.
